(19) United States
(12) Patent Application Publication
(10) Pub. No.: US 2004/0121916 A1
(43) Pub. Date: Jun. 24, 2004

(54) Thickener for excavating slurry, excavating slurry using the the thickener, and cast-in-place underground pile work method and underground continuius wall work method using the excavating slurry

(76) Inventors: Katsuyuki Kono, Shiga-gun (JP); Atsushi Motoyama, Akashi-shi (JP); Keiichi Nakamoto, Takatsuki-shi (JP); Jinichi Ooi, Sakata-shi (JP); Makoto Kimura, Sakata-shi (JP); Katsuhisa Abe, Sakata-shi (JP); Eikichi Harada, Higashitagawa-gun (JP)

Correspondence Address: SUGHRUE MION, PLLC, 2100 PENNSYLVANIA AVENUE, N.W., SUITE 800, WASHINGTON, DC, 20037, US

(21) Appl. No.: 10/474,913

(22) PCT Filed: Apr. 25, 2002
(86) PCT No.: PCT/JP02/04167

(30) Foreign Application Priority Data
Apr. 27, 2001 (JP) 2001-132292

(51) Int. Cl. C09K 7/02

(52) U.S. Cl. 507/100

(57) ABSTRACT

Subjects for the present invention are to provide a thickening agent for excavation stabilizing slurries which has excellent cement contamination resistance, is difficult to putrefy, and is prevented from bubbling, which may be problematic in construction works, and to provide an excavation stabilizing slurry containing the thickening agent and a cast-in-place underground pile method and an diaphragm wall construction method each using the slurry.

The present invention provides a thickening agent for excavation stabilizing slurries which contains an emulsion thickening with an alkali, wherein in a strong agitation bubbling test of a mixture prepared by adding an alkaline substance to the thickening agent, the resulting mixture has an apparent specific gravity of 1.05 g/ml or higher as measured immediately after the strong agitation and has an apparent specific gravity of 1.10 g/ml or higher as measured at 10 minutes after the strong agitation. This thickening agent is used to prepare an excavation stabilizing slurry.

### TECHNICAL FIELD

The present invention relates to a thickening agent for excavation stabilizing slurries for use in preventing the wall of a hole formed by excavation from collapsing and to an excavation stabilizing slurry (hereinafter sometimes referred to simply as “slurry”) containing the same, especially an underground excavation stabilizing slurry for use in underground excavation works by excavation methods such as the cast-in-place pile method and diaphragm wall construction method. More particularly, the present invention relates to an excavation stabilizing slurry which can have an improved degree of reuse by being prevented from deteriorating during excavation due to the contamination of the soil excavated, cement components, and salts into the excavation stabilizing slurry and by being prevented from deteriorating biochemically (due to bacteria), and to excavation methods using the same.

### BACKGROUND ART

In the field of underground construction works including subway construction works, excavation methods such as the diaphragm wall construction method and underground pile method are extensively used. For example, the diaphragm wall construction method, which is a general method of construction for use in constructing a concrete structure underground, begins with underground excavation. This excavation is conducted while the excavation hole is kept being filled with an excavation stabilizing slurry containing a clay mineral, e.g., bentonite, in order to conduct the excavation while preventing the wall of the excavation hole from collapsing. In excavation methods using this excavation stabilizing slurry, the excavation stabilizing slurry is thought to function by the following mechanism. When the excavation stabilizing slurry infiltrates into the excavation wall, the clay mineral, e.g., bentonite, is caught among soil particles and thus accumulates to thereby form a fluid loss layer called a mudcake. This fluid loss layer prevents the wall face from becoming soft, and the hydraulic pressure of the excavation stabilizing slurry prevents the wall face from collapsing. The diaphragm wall construction method is a construction method in which after excavation is conducted while stabilizing the wall of the excavation hole as described above, a reinforcing-bar cage is inserted into the pit and concrete is placed to form a continuous concrete structure. On the other hand, the underground pile method is a construction method in which after excavation is conducted while stabilizing the wall of the excavation hole, concrete is placed in the hole to form a columnar concrete structure. In the concrete placing, the excavation stabilizing slurry is displaced by the concrete. It is desirable to reuse the excavation stabilizing slurry recovered.

Although excavation methods using an excavation stabilizing slurry can be extensively used in various construction methods, they are most effective in the construction methods in which the excavation stabilizing slurry is displaced by concrete, such as, in particular, the diaphragm wall construction method and underground pile method.

Functions required of excavation stabilizing slurries for use in excavation methods such as the diaphragm wall construction method and cast-in-place pile method are as follows. The first function is to prevent a trench (hole) formed by vertically excavating the earth from collapsing. The second function is to be smoothly displaced by the concrete which is placed in the excavation stabilizing slurry for constructing a concrete structure in a trench (hole) formed by excavation to thereby enable the placing of concrete to attain satisfactory quality. There has been a serious problem in the exercise of such functions that the soil excavated, ground water, cement components, and the like contaminate the excavation stabilizing slurry or general bacteria grow therein to cause quality deterioration.

An excavation stabilizing slurry having a reduced bentonite content is used in place of the early excavation stabilizing slurry containing bentonite as a major component, in order to eliminate those problems in excavation methods using an excavation stabilizing slurry and from the standpoints of ease of waste slurry treatment in discarding spent excavation stabilizing slurries, etc. However, a reduction in bentonite content in an excavation stabilizing slurry results in a decrease in the viscosity of the excavation stabilizing slurry, and this reduces the ability to prevent wall face collapsing (fluid loss property) or causes bentonite precipitation, making it impossible to use the fluid as an excavation stabilizing slurry. Because of this, an excavation stabilizing slurry prepared by adding a thickening agent, e.g., carboxymethyl cellulose (hereinafter referred to as “CMC”), to a liquid generally obtained by dispersing a clay mineral, e.g., bentonite, in water and an excavation stabilizing slurry containing CMC as a major component were recently developed for use in excavation methods. Thus, techniques for preventing the quality deterioration of excavation stabilizing slurries have progressed.

As described above, the method mainly used for preparing excavation stabilizing slurries heretofore in use is to employ bentonite alone or a combination of bentonite and CMC as a base and add thereto a dispersant, e.g., poly(sodium acrylate), pH regulator, and inorganic treating agents, as a blocking agent for calcium ions or the like, e.g., sodium carbonate or sodium hydrogen carbonate according to need. This excavation stabilizing slurry heretofore in use is a dispersion-system excavation stabilizing slurry which not only has a protective-colloid effect attributable to the adsorption of CMC onto soil particles and a dispersion-stabilizing function attributable to charges of CMC, but also attains an increased change density on the surface of soil particles due to the addition of low-molecular weight poly(sodium acrylate). However, since this excavation stabilizing slurry heretofore in use is excellent in wetting ability, which reduces the interfacial energy of the surface of soil particles and thereby makes the soil particle surface more wettable by water, it has the following problem. When this excavation stabilizing slurry is used for excavating a soil such as a silt layer or clay layer, a large proportion of the soil which has been excavated and has contaminated the excavation stabilizing slurry is dispersed therein as fine soil particles. As a result, the specific gravity of the slurry increases in a short time period, leading to quality deterioration, etc.

The excavation stabilizing slurries heretofore in use further have problems that since they contain CMC, which is derived from natural cellulose, as a base, it is apt to be biochemically degraded and putrefied by general bacteria to deteriorate the quality of the excavation stabilizing slurries, and that since CMC is difficult to disperse and dissolve, an excavation stabilizing slurry having stable properties cannot be obtained. Although some degree of bactericidal resistance can be imparted by using a highly substituted CMC having an increased degree of substitution with carboxymethyl groups or by using the CMC in combination with a bactericide, the effect is limited. There is hence a desire for a new additive.

Furthermore, there have been other problems such as the following. With the progress of excavation, fine soil particles accumulate in the excavation stabilizing slurry. When the excavation stabilizing slurry is displaced by concrete or in case where ground water or seawater contaminates the excavation stabilizing slurry during excavation, then the bentonite or CMC contained in the excavation stabilizing slurry coagulates by the action of calcium ions contained in the cement or of salts contained in the ground water or seawater to impair the dispersion function of the excavation stabilizing slurry. In case where the coagulation proceeds further, the excavation stabilizing slurry gels and hence immediately deteriorates in quality. Thus, the excavation stabilizing slurry becomes difficult to handle or is considerably impaired in the ability to prevent wall face collapsing (fluid loss property), and waste slurries are yielded in large quantities.

A technique for mitigating the problem of contamination with cement, etc. is known, which comprises adding a dispersant of, e.g., the polycarboxylic acid type or ligninsulfonic acid type and an alkali carbonate or the like to an excavation stabilizing slurry during the preparation thereof or when the excavation stabilizing slurry which has been contaminated with cement is reconditioned. However, this technique has problems, for example, that it is difficult to prevent the problem of cement contamination for long, the amount of the additives including a dispersant should be considerably increased, and it is necessary to add these additives every time when the excavation stabilizing slurry is reused. Because of these, this excavation stabilizing slurry is reused usually once or about two times at the most. Use of this technique presently results in an increase in the cost of excavation stabilizing slurries themselves and leads to an increase in construction cost. Furthermore, those dispersants, which are used also for enhancing the dispersibility and other properties of the thickening agent, e.g., CMC, do not function as a thickening agent because of their low molecular weights.

On the other hand, it is known that an emulsion is added to an excavation stabilizing slurry before use in order to improve various performances. For example, JP 60-133084A discloses a mud composition for improving dispersibility which is prepared by incorporating into a bentonite dispersion a water-in-oil type emulsion obtained by polymerizing monomers including sodium acrylate by water-in-oil emulsion polymerization. However, this composition is difficult to handle because it has inflammability, and falls under the category of hazardous materials according to the fire protection law. There also is a problem that oil contaminates waste slurry.

Moreover, JP 8-157820A, 2000-212551A, 2000-212552A, 2001-31959A, 2001-55565A, 2001-64636A, and 2001-64637A each disclose an excavation stabilizing slurry composition which contains an oil-in-water type alkali-thickening emulsion containing a copolymer obtained by polymerizing (meth)acrylic acid and a (meth)acrylic ester by oil-in-water emulsion polymerization, for the purpose of improving thickening ability or improving fluid loss property.

However, addition of the emulsion described in Examples shown in those publication documents to an excavation stabilizing slurry poses the following problem. The copolymer described above and the emulsifying agent both contained in the emulsion separate out. Since the copolymer and emulsifying agent have surface activity, they enhance the foamability of the excavation stabilizing slurry to froth the excavation stabilizing slurry, for example, during preparation thereof or separation of soil and sand from the excavation stabilizing slurry for reuse. The bubbling of the excavation stabilizing slurry causes the following and other problems in construction works: a pressure balance between the excavation stabilizing slurry and the excavation trench wall is destroyed due to the decrease in the specific gravity of the excavation stabilizing slurry, resulting in wall face collapsing; froth overflow occurs from the reserve tank; the circulating pump idles; it becomes impossible to control the excavation stabilizing slurry based on specific gravity; and it becomes impossible to make a trench wall observation with an ultrasonic measuring equipment after excavation.

In order to overcome the problem of bubbling in excavation stabilizing slurries, a technique is often employed which comprises further adding an antifoamer. However, this technique is undesirable in that it is difficult to always prevent the problem of bubbling and an antifoamer should be added in a considerably large amount every time when the excavation stabilizing slurry is prepared or reused, and that the large antifoamer amount results in an increase in excavation stabilizing slurry cost and, in some cases, leads to a decrease in excavation stabilizing slurry properties, such as, e.g., water separation due to sedimentation.

Accordingly, one object of the present invention under the related-art circumstances described above is to provide: a thickening agent for excavation stabilizing slurries which has excellent cement contamination resistance, is difficult to putrefy, and is prevented from bubbling, which may be problematic in construction works; an excavation stabilizing slurry containing the agent; and a cast-in-place underground pile method and an diaphragm wall construction method each using the slurry.

Another object of the present invention is to provide: an excavation stabilizing slurry which has a reduced wetting action on the excavation soil contaminating into the excavation stabilizing slurry and is thereby prevented from suffering an increase in specific gravity due to the accumulation of fine soil particles and which is effective in reducing the amount of excavation stabilizing slurries to be discarded; and a cast-in-plane underground pile method and an diaphragm wall construction method each using the slurry.

Still another object is to provide: an excavation stabilizing slurry which contains a thickening agent containing an alkali-thickening emulsion in place of the CMC used as a base in related-art excavation stabilizing slurries, and which thereby is prevented from suffering the quality deterioration caused by the contamination of cement components contained in concrete or of salts contained in ground water or suffering the quality deterioration caused by biochemical degradation due to general bacteria, attains an increased degree of reuse, and can be reused; and a cast-in-plane underground pile method and an diaphragm wall construction method each using the slurry.

### DISCLOSURE OF THE PRESENT INVENTION

The present inventors made intensive investigations through various approaches in order to accomplish those aims. As a result, it was found that the bubbling of an excavation stabilizing slurry was prevented by a thickening agent for excavation stabilizing slurries which contains an emulsion thickening with an alkali and is characterized in that in a strong agitation bubbling test of a mixture prepared by adding an alkaline substance to the thickening agent, the resulting mixture has an apparent specific gravity of 1.05 g/ml or higher as measured immediately after the strong agitation and has an apparent specific gravity of 1.10 g/ml or higher as measured at 10 minutes after the strong agitation. It was thus found that the objects described above are accomplished with this thickening agent.

The thickening agent containing an alkali-thickening emulsion and having the specific bubbling properties described above was found to have such a property that even when a mixture prepared by adding an alkali substance to the thickening agent is subjected, for example, to an operation for forcibly containing bubbles thereinto (e.g., agitation, dropping from a height, etc.), bubbles are difficult to be held in the liquid and/or the bubbles present in the liquid are apt to go out. It was found that use of this thickening agent in an excavation stabilizing slurry can eliminate various problems attributable to excavation stabilizing slurry bubbling, i.e., the following problems: a pressure balance between the excavation stabilizing slurry and the excavation trench wall is destroyed due to a decrease in the specific gravity of the excavation stabilizing slurry, resulting in wall face collapsing; froth overflow occurs from the reserve tank; the circulating pump idles; it becomes impossible to control the excavation stabilizing slurry based on specific gravity; and it becomes impossible to make a trench wall observation with an ultrasonic measuring equipment after excavation. Thus, excavation methods such as the diaphragm wall construction method and underground pile method can be stably carried out and the wall faces formed by excavation can be prevented from collapsing without fail. Moreover, the excavation stabilizing slurry containing the thickening agent of the present invention is significantly reduced in bubbling unlike the excavation stabilizing slurries containing another emulsion or an emulsifying agent or the like as an additive and, hence, enables construction works to be stably conducted without the necessity of further adding an antifoamer.

Furthermore, it has been found that by using as a base the thickening agent containing an alkali-thickening emulsion and having the specific properties described above, it is possible to minimize the increase in slurry specific gravity caused by the accumulation of fine soil particles, quality deterioration caused by the contamination of cement components contained in concrete or of salts contained in ground water, and quality deterioration caused by biochemical degradation due to general bacteria.

Although details of the mechanism of those functions are unclear, the following is thought. In excavation stabilizing slurries heretofore in use, the excavation soil which has contaminated the excavation stabilizing slurries disperses therein as fine particles because these slurries contain CMC as a base. In contrast, when the thickening agent of the present invention, which contains an emulsion thickening with an alkali, is incorporated into ingredients for an excavation stabilizing slurry, a polymer in the emulsion is adsorbed onto the surface of excavation soil particles and prevents, based on the protective-colloid effect, the excavation soil from dispersing as fine particles.

It is further thought that the excavation stabilizing slurry of the present invention has a dispersion-stabilizing effect attributable to high ionicity, besides the protective-colloid effect, and is thereby prevented from being deteriorated in quality by the contamination of cement components contained in concrete or of salts contained in ground water.

It is furthermore thought that since the excavation stabilizing slurry of the present invention contains as a base thereof the thickening agent of the present invention, which is a synthetic thickener containing an alkali-thickening emulsion, it can be prevented from being deteriorated in quality by general bacteria through biochemical degradation as compared with prior-art excavation stabilizing slurries containing CMC, which is derived from natural cellulose, as a base.

The alkali-thickening emulsion contained in the thickening agent for excavation stabilizing slurries of the present invention is an emulsion comprising an aqueous medium and, dispersed therein, a polymer thickening with an alkali, i.e., an aqueous emulsion. Compared to water-in-oil type polymer emulsions, this emulsion hence has an advantage that it is less apt to inflame and is highly safe.

In addition, the excavation stabilizing slurry containing the thickening agent of the present invention has excellent cement contamination resistance and is less apt to putrefy as compared with those containing CMC. The excavation stabilizing slurry according to the present invention can hence be reused many times to diminish waste slurry treatment and is advantageous also from the standpoint of profitability.

### BEST MODE FOR CARRYING OUT THE PRESENT INVENTION

The bubbling properties of the thickening agent of the present invention, which contains an alkali-thickening emulsion, are examined specifically by the following method.

The oil-in-water type alkali-thickening emulsion to be contained in the thickening agent for excavation stabilizing slurries is mixed with ion-exchanged water and 0.5 N aqueous NaOH solution to prepare an aqueous solution having a concentration of 0.2% by weight in terms of the concentration of the solid component (nonvolatile matter) of the emulsion and a pH of 8.0±0.1. In a 1-L stainless-steel beaker (barrel diameter 107 mm×height 120 mm; manufactured by Sogo Rikagaku Glass Seisaku-sho K.K.) is placed 250.0 g of the aqueous solution. Thereto is added 50.0 g of JIS test powders I, Class 7 (JIS Z8901; Kanto loam; fine grain; manufactured by The Association of Powder Process Industry and Engineering, Japan). While being kept at 20° C., this mixture is agitated at a rotational speed of 8,000 rpm for 3 minutes with Disper (T.K. Autohumomixer Type SL; stainless-steel interchangeable blade for Homodisper, diameter 45 mm; manufactured by Tokushu Kika Kogyo Co., Ltd.) which has been regulated so that the end of the stirring blade is located at a height of 10 mm from the bottom of the beaker. Thus, a solid-containing liquid is obtained. This liquid is immediately placed in a 200 ml measuring cylinder made of glass (manufactured by Sogo Rikagaku Glass Seisaku-sho K.K.) to measure the apparent specific gravity thereof just after the strong agitation. This cylinder containing the liquid is allowed to stand for 10 minutes. Thereafter, 0.1 g of an antifoamer (Aqualen 3062; manufactured by Kyoeisha Chemical Co., Ltd.) is added to destroy the bubbles present on the top and the apparent specific gravity of the liquid is measured.

A thickening agent which, when examined through the test described above, gives an apparent specific gravity of the liquid of 1.05 g/ml or higher immediately after the strong agitation and an apparent specific gravity of the liquid of 1.10 g/ml or higher at 10 minutes after the strong agitation corresponds to the specific bubbling properties in the present invention.

A thickening agent having the specific bubbling properties according to the present invention can be obtained by conducting the following various methods in suitably regulated manners. Namely, the bubbling of an excavation stabilizing slurry is attributed to the fact that the copolymer (thickening polymer) constituting emulsion particles and the emulsifying agent used in emulsion polymerization have surface activity. By applying a suitable combination of various elements which relate to these, the specific bubbling properties described above can be attained.

As a result of various investigations on the bubbling of excavation stabilizing slurries, it has been found that the influence of thickening polymers is especially considerable and to enhance the hydrophilicity of a thickening polymer is effective in reducing the bubbling. This is because it is presumed that the lower the hydrophilicity of a thickening polymer and the larger the hydrophobic part thereof, the more the thickening polymer undergoes hydrophobic orientation to the bubbles incorporated in the excavation stabilizing slurry, for example, during preparation thereof or during separation of soil and sand for reuse of the excavation stabilizing slurry to thereby produce the higher effect of stabilizing bubbles. It has hence been found that to enhance the hydrophilicity of a thickening polymer is effective in eliminating the problem of excavation stabilizing slurry bubbling. Specifically, it has been found that it is effective to use a copolymer comprising, as comonomer units, a large amount of carboxyl-containing polymerizable monomers and highly hydrophilic nonionic monomers to be copolymerizable therewith.

More specifically, it is preferred to use a copolymer comprising, as comonomer units, one or more carboxyl-containing polymerizable monomers (including ones in which the carboxyl groups are partly or wholly a salt) in a total amount of 50% by weight or larger and a nonionic polymerizable monomer having a solubility in 20° C. water of 3% by weight or higher (hereinafter this copolymer is sometimes referred to especially as copolymer [A]) as the thickening polymer in the alkali-thickening emulsion. This copolymer especially preferably is an emulsion copolymer having an anionic nature obtained by the emulsion copolymerization of monomers comprising acrylic acid and/or methacrylic acid (including one in which the carboxyl group is partly or wholly a salt) and the nonionic polymerizable monomers described above as main components.

The term carboxyl-containing polymerizable monomers (including ones in which the carboxyl groups are partly or wholly a salt) as used herein means polymerizable monomers containing one or more carboxyl groups and/or polymerizable monomers containing one or more carboxyl group salts (including ones which have two or more carboxyl groups and in which one or more of the carboxyl groups are a salt). Hereinafter, the polymerizable monomers will be sometimes referred to simply as “polymerizable monomers containing one or more carboxyl groups and/or salts thereof”.

Of the polymerizable monomers in the copolymer [A], the polymerizable monomers containing one or more carboxyl groups and/or salts thereof have been copolymerized in a total amount of preferably 50% by mass or larger, more preferably from 50 to 90% by mass, even more preferably from 55 to 80% by mass. The amount of the nonionic polymerizable monomer having a solubility in 20° C. water of 3% by mass or higher which has been copolymerized is preferably 50% by mass or smaller, more preferably from 10 to 50% by mass, even more preferably from 20 to 45% by mass.

When the amounts thereof are within those ranges, the thickening agent containing an alkali-thickening emulsion containing the copolymer [A] can be easily regulated so as to have bubbling properties within the specific range according to the present invention.

Of the polymerizable monomers containing one or more carboxyl groups and/or salts thereof, which are an essential component of the copolymer [A], the polymerizable monomers containing one or more carboxyl groups are not particularly limited. Examples thereof include carboxyl-containing polymerizable monomers such as (meth)acrylic acid, itaconic acid, crotonic acid, maleic acid, maleic anhydride, and the like. The polymerizable monomers containing one or more carboxyl group salts are salts of these carboxyl-containing polymerizable monomers and are not particularly limited. Examples thereof include salts with metals such as lithium, sodium, potassium, rubidium, cesium, magnesium, calcium, strontium, barium, manganese, chromium, iron, cobalt, nickel, copper, zinc, aluminum, tin, lead, silver, cerium, and the like; ammonium salts and hydroxyammonium salts; salts with organic amines such as trimethylamine, triethylamine, monoethanolamine, diethanolamine, triethanolamine, piperidine, pyridine, and the like; and the like. These polymerizable monomers containing one or more carboxyl groups and/or salts thereof may be used alone or in combination of two or more thereof according to need. Most preferred of the polymerizable monomers containing one or more carboxyl groups and/or salts thereof enumerated above is (meth)acrylic acid because it has a satisfactory balance between stability in polymerization and alkali-thickening properties.

The nonionic polymerizable monomers having a solubility in 20° C. water of 3% by mass or higher are not particularly limited. Examples thereof include methyl acrylate, hydroxyethyl acrylate, hydroxyethyl methacrylate, hydroxypropyl acrylate, hydroxypropyl methacrylate, methyl α-(hydroxymethyl)acrylate, ethyl α-(hydroxymethyl)acrylate, polyethylene glycol acrylate, polyethylene glycol methacrylate, polyethylene glycol polypropylene glycol acrylate, polyethylene glycol polypropylene glycol methacrylate, isopropenyloxazoline, polyethylene glycol (2-(1-propenyl)-4-nonyl)phenyl ether, polyethylene glycol (2-(l-propenyl))phenyl ether, polyethylene glycol 2-propenyl ether, polyethylene glycol 3-methyl-3-butenyl ether, allyl alcohol, polyoxyethylene allyl ether, N-vinyl-2-pyrrolidone, acrylonitrile, acrylamide, methacrylamide, diacetone acrylamide, and the like. These nonionic polymerizable monomers having a solubility in 20° C. water of 3% by mass or higher may be used alone or in combination of two or more thereof according to need. By using a nonionic polymerizable monomer having a solubility in 20° C. water of 3% by mass or higher, i.e., a highly hydrophilic monomer, as a comonomer together with the polymerizable monomer containing one or more carboxyl groups and/or salts thereof, the specific bubbling properties according to the present invention are effectively attained. Of the nonionic polymerizable monomers enumerated above, the polymerizable (meth)acrylic ester monomers are more preferred in that they have a satisfactory balance between copolymerizability and hydrophilicity. Most preferred of these is methyl acrylate.

Polymerizable monomers other than the polymerizable monomers shown above may be further copolymerized as long as this does not considerably reduce the alkali-thickening properties and low-bubbling properties of the polymer itself. Such other polymerizable monomers are not particularly limited. Examples thereof include methyl methacrylate; polymerizable (meth)acrylic ester monomers which are esters of (meth)acrylic acid with an alcohol having 2 to 18 carbon atoms (excluding cyclic alcohols), such as ethyl (meth)acrylate, propyl (meth)acrylate, butyl (meth)acrylate, and 2-ethylhexyl (meth)acrylate; polymerizable styrene compound monomers such as styrene, α-methylstyrene, vinyltoluene, p-methylstyrene, chloromethylstyrene, and ethylvinylbenzene; cyclohexyl-containing polymerizable monomers such as cyclohexyl (meth)acrylate and cyclohexylmethyl (meth)acrylate; unsaturated esters such as methyl crotonate, vinyl acetate, and vinyl propionate; dienes such as butadiene, isoprene, 2-methyl-1,3-butadiene, and 2-chloro-1,3-butadiene; the monoester of (meth)acrylic acid with polypropylene glycol; basic polymerizable monomers such as methylaminoethyl (meth)acrylate, dimethylam inoethyl (meth)acrylate, dimethylaminopropyl (meth)acrylate, dibutylaminoethyl (meth)acrylate, vinylpyridine, and vinylimidazole; polymerizable monomers derived from carbolic acid, such as vinylphenol; polymerizable monomers containing an aziridine group, such as 2-aziridinylethyl (meth)acrylate and (meth)acryloylaziridine; polymerizable monomers containing an epoxy group, such as glycidyl (meth)acrylate and (meth)allyl glycidyl ether; polymerizable monomers containing a hydrolyzable silicon group directly bonded to a silicon atom, such as vinyltrimethoxysilane, vinyltriethoxysilane, y-(meth)acryloylpropyltrimethoxysilane, vinyltris(2-methoxyethoxy)silane, and allyltriethoxysilane; halogen-containing polymerizable monomers such as vinyl fluoride, vinylidene fluoride, vinyl chloride, and vinylidene chloride; polyfunctional (meth)acrylic esters having two or more polymerizable unsaturated groups in the molecule, such as esters of (meth)acrylic acid with a polyhydric alcohol such as ethylene glycol, polyethylene glycol, 1,3-butylene glycol, diethylene glycol, 1,6-hexanediol, neopentyl glycol, propylene glycol, polypropylene glycol, trimethylolpropane, pentaerythritol, or dipentaerythritol; polyfunctional allyl compounds having two or more polymerizable unsaturated groups in the molecule, such as diallyl phthalate, diallyl maleate, and diallyl fumarate; polymerizable polyfunctional polymerizable monomers such as allyl (meth)acrylate, methallyl (meth)acrylate, and divinylbenzene; cyanurates such as triallyl cyanurate; polymerizable monomers containing a strong-acid group, such as unsaturated sulfonic acids such as vinylsulfonic acid, (meth)allylsulfonic acid, 2-sulfoethyl (meth)acrylate, 3-sulfopropyl (meth)acrylate, 4-sulfobutyl (meth)acrylate, 2-acrylamido-2-methylpropanesulfonic acid, and styrenesulfonic acid, univalent-metal salts, bivalent-metal salts, ammonium salts, and organic-amine salts of these, and polymerizable monomers containing an acid phosphoric ester group, such as 2-(meth)acryloyloxyethyl acid phosphate, 2-(meth)acryloyloxypropyl acid phosphate, 2-(meth)acryloyloxy-3-chloropropyl acid phosphate, and 2-(meth)acryloyloxyethyl phenyl phosphate; and the like. These polymerizable monomers may be used alone or in combination of two or more thereof according to need.

Preferred of such other polymerizable monomers enumerated above are the polymerizable monomers containing a strong-acid group (e.g., unsaturated sulfonic acids and univalent-metal salts, bivalent-metal salts, ammonium salts, and organic-amine salts of these, polymerizable monomers containing an acid phosphoric ester group, and the like). This is because by using such a monomer containing a strong-acid group as a comonomer, in particular, by using the monomer mostly in initial polymerization in emulsion polymerization, stability during the emulsion polymerization can be improved while maintaining low-bubbling properties. This effect is presumed to be produced by the following mechanism. A water-soluble polymer containing many strong-acid groups is yielded in the initial polymerization, and this water-soluble polymer functions like a protective colloid or emulsifying agent in the later polymerization step and thus contributes greatly to polymerization stability. The term initial polymerization herein means the first step in the emulsion polymerization process roughly divided into three stages, i.e., an initial polymerization step, a dropping step, and an aging step. In the first step, a given amount of polymerizable monomers are placed en bloc in an initial tank containing water or an aqueous emulsifying agent solution placed therein and are polymerized for a given time period. This step is an important step which influences the number of particles, particle diameter, and stability in the emulsion polymerization. The water-soluble polymer yielded in this initial polymerization has high hydrophilicity because it is a polymer having many carboxyl groups and strong-acid groups incorporated therein. The bubbling properties of this water-soluble polymer itself do not adversely influence the specific bubbling properties according to the present invention. Consequently, even when the amount of an emulsifying agent to be used in combination therewith is reduced, for example, to 2 parts by mass or smaller per 100 parts by mass of all polymerizable monomers, the water-soluble polymer is sufficiently effective in improving polymerization stability.

Those polymerizable monomers containing a strong-acid group may be incorporated alone, or two or more thereof may be incorporated. Especially preferred of those polymerizable monomers containing a strong-acid group are the unsaturated sulfonic acids because they bring about satisfactory polymerization stability. More preferred are 2-sulfoethyl (meth)acrylate, 3-sulfopropyl (meth)acrylate, 4-sulfobutyl (meth)acrylate, 2-acrylamido-2-methylpropanesulfonic acid, styrenesulfonic acid, and univalent-metal salts, bivalent-metal salts, ammonium salts, and organic-amine salts of these, because they have satisfactory copolymerizability.

A chain-transfer agent may be used besides those polymerizable monomers for the purpose of regulating the molecular weight of the polymer constituting emulsion particles or improving polymerization stability during the emulsion polymerization. The chain-transfer agent is not particularly limited, and examples thereof include compounds having a high coefficient of chain transfer, such as: compounds containing a mercapto group, e.g., mercaptoethanol, mercaptopropionic acid, and t-dodecyl mercaptan; carbon tetrachloride; isopropyl alcohol; toluene; and the like. These chain-transfer agents may be used alone or in combination of two or more thereof. Although these chain-transfer agents may be used in each step in the emulsion polymerization, it is especially preferred to use them in combination with the polymerizable monomer containing a strong-acid group mostly in initial polymerization in the emulsion polymerization. This is because use of a chain-transfer agent in this manner further improves stability during the emulsion polymerization.

In a more preferred method, the concentration of polymerizable monomers in the reaction mixture for initial polymerization is regulated to 5 to 45% by mass, and in the dropping step, dropping of pre-emulsion that is prepared using an increased amount water amount and using polymerizable-monomers concentration reduced to 50% by mass or lower is conducted. Thus, stability during the emulsion polymerization can be improved even more.

The copolymerization of the carboxyl-containing polymerizable monomer with the nonionic polymerizable monomer having a solubility in 20° C. water of 3% by mass or higher can be easily conducted by an ordinary emulsion polymerization method which has been known hitherto, that is, by the method of oil-in-water emulsion polymerization in which monomer ingredients are emulsion-polymerized in water. This emulsion polymerization method is preferred because the polymerization can yield a high-molecular weight polymer in a high concentration, a low handling viscosity can be obtained, and the production cost is low. Furthermore, since the copolymer obtained by the emulsion polymerization method has a high molecular weight and high thickening properties, the excavation stabilizing slurry containing this copolymer has excellent fluid loss properties.

This emulsion polymerization is conducted usually using an emulsifying agent, polymerization initiator, reducing agent, chain-transfer agent, and the like. The emulsifying agent is not particularly limited, and use can be made of, for example, anionic surfactants, nonionic surfactants, cationic surfactants, amphoteric surfactants, polymeric surfactants, and reactive surfactants of these types. These surfactants may be used alone or in combination of two or more thereof according to need. In some cases, however, the polymerization can be conducted using no emulsifying agent. The amount of the emulsifying agent to be used is preferably 2 parts by mass or smaller, more preferably 1 part by mass or smaller, even more preferably 0.5 parts by mass or smaller, per 100 parts by mass of all polymerizable monomers.

Examples of the anionic surfactants include alkyl sulfate salts such as sodium dodecyl sulfate, potassium dodecyl sulfate, and ammonium alkyl sulfates; sodium dodecyl polyglycol ether sulfate; alkylsulfonates such as sodium sulforicinoate and sulfonated paraffin salts; alkylsulfonates such as sodium dodecylbenzenesulfonate and alkali metal sulfates of alkaliphenol hydroxyethylenes; (higher alkyl)naphthalenesulfonic acid salts; naphthalenesulfonic acid/formalin condensates; fatty acid salts such as sodium laurate, triethanolamine oleate, and triethanolamine abietate; polyoxyalkyl ether sulfate salts; polyoxyethylene carboxylate sulfate salts; polyoxyethylene alkyl ether sulfate salts; polyoxyethylene phenyl ether sulfate salts; polyoxyethylene substituted-phenyl ether sulfate salts; polyoxypropylene polyoxyethylene alkyl ether sulfate salts; alkylallyl polyether sulfate salts; dialkyl succinate sulfonic acid salts; polyoxyethylene alkylaryl sulfate salts; reactive anionic emulsifying agents having a double bond; and the like. These may be used alone or in combination of two or more thereof according to need.

Examples of the nonionic surfactants include polyoxyethylene alkyl ethers; polyoxyethylene alkylaryl ethers; sorbitan aliphatic esters; polyoxyethylene sorbitan aliphatic esters; aliphatic monoglycerides such as glycerol monolaurate; poly(oxyethylene-oxypropylene) copolymers; condensates of ethylene oxide with an aliphatic amine, amide, or acid; and the like. These may be used alone or in combination of two or more thereof according to need.

Examples of the polymeric surfactants include poly(vinyl alcohol) and modifications thereof; water-soluble (meth)acrylic acid polymers; water-soluble hydroxyethyl (meth)acrylate polymers; water-soluble hydroxypropyl (meth)acrylate polymers; polyvinylpyrrolidone; and the like. These may be used alone or in combination of two or more thereof according to need.

In the alkali-thickening emulsion for use in the thickening agent for excavation stabilizing slurries of the present invention, the content of the emulsifying agent used for the emulsion copolymerization of monomer ingredients has been regulated so as to be lower than ordinary values and/or the emulsifying agent used is one having low bubbling ability. Due to this, the specific bubbling properties according to the present invention can be more effectively attained.

In the present invention, to select an emulsifying agent having the following bubbling properties among the emulsifying agents for the emulsion polymerization is especially effective in attaining the specific bubbling properties according to the present invention. Namely, preferred kinds of emulsifying agents among the emulsifying agents enumerated above are especially ones which have the following bubbling properties: when a 1% by mass aqueous solution of the emulsifying agent is examined through a bubbling test by the Ross-Miles method at 25° C. (JIS K 3362), the height of the froth as measured immediately after the dropping is 200 mm or smaller and the froth height as measured at 5 minutes after the dropping is 100 mm or smaller. It is preferred to use an emulsifying agent having bubbling properties within the range shown above and to use in an amount of 2 parts by mass or smaller. This is because when a thickening agent containing the alkali-thickening emulsion thus obtained is used in an excavation stabilizing slurry, this slurry is less apt to have problems, for example, that the emulsifying agent contained in the emulsion separates out and enhances the bubbling properties of the excavation stabilizing slurry, thereby bubbling the excavation stabilizing slurry, for example, during preparation thereof or during separation of soil and sand for preparation for reuse of the excavation stabilizing slurry, as stated above. It is especially preferred to apply such an emulsifying agent in combination with the specific copolymer [A] described above.

The polymerization initiator for the emulsion polymerization used is one which decomposes thermally or through an oxidation-reduction reaction to generate a radical molecule. It is especially preferred to use a water-soluble initiator. Examples thereof include persulfates such as potassium persulfate, ammonium persulfate, and sodium persulfate; water-soluble azo compounds such as 2,2′-azobis(2-amidinopropane) dihydrochloride and 4,4′-azobis(4-cyanopentanoic acid); heat decomposition type initiators such as hydrogen peroxide; redox polymerization initiators such as a combination of hydrogen peroxide and ascorbic acid, combination of t-butyl hydroperoxide and Rongalit, combination of potassium persulfate and a metal salt, and combination of ammonium persulfate and sodium hydrogen sulfite; and the like. These may be used alone or in combination of two or more thereof according to need.

The polymerization temperature in the emulsion polymerization need not be particularly limited. However, it is generally preferably from 0 to 100° C., more preferably from 40 to 95° C. The polymerization period also need not be particularly limited. However, it is generally preferably from 2 to 15 hours. A hydrophilic solvent, additives, and the like can be added in conducting the emulsion polymerization as long as this does not adversely influence polymerization stability or the properties of the thickening polymer to be obtained.

Methods for adding polymerizable monomer ingredients to an emulsion polymerization reaction system need not be particularly limited. Use can be made of the monomer dropping method, pre-emulsion method, en bloc addition method, constant addition method, multistage dropping method, power feed method, seed method, or the like. Preferred of these methods is the pre-emulsion method because this method brings about improved stability in the emulsion polymerization as stated above. The nonvolatile content (thickening polymer) in the emulsion obtained through the emulsion polymerization reaction is preferably 60% by mass or lower. In case where the nonvolatile content thereof exceeds 60% by mass, the emulsion has too high a viscosity or cannot retain dispersion stability and there is the possibility of coagulation.

Besides being the emulsion obtained by the emulsion polymerization method described above, the emulsion to be contained in the thickening agent for excavation stabilizing slurries of the present invention may be, for example, one produced by obtaining a copolymer by copolymerization by another method, e.g., microsuspension polymerization or solution polymerization, and redispersing the copolymer using an emulsifying agent or the like according to need.

The alkali-thickening emulsion to be contained in the thickening agent for excavation stabilizing slurries of the present invention is presumed to thicken by the following mechanism. The thickening polymer in the emulsion comes to have enhanced hydrophobicity by the action of an alkaline substance. As a result, the particles of the thickening polymer dissolve partly or wholly in the water or swell or undergo both, thereby thickening the emulsion. The weight-average molecular weight of the thickening polymer for use in the thickening agent of the present invention is not particularly limited. However, it is generally preferably from 100,000 to 3,000,000, more preferably from 200,000 to 1,500,000. In case where the weight-average molecular weight of the polymer is lower than 100,000, the polymer does not function as a thickening agent and, as a result, the excavation stabilizing slurry has a reduced viscosity and does not have sufficient fluid loss properties.

The average particle diameter of the particles of the thickening polymer in the emulsion is not particularly limited. However, it is generally preferably from 50 nm to 50 μm, more preferably from 100 nm to 30 μm. A thickening polymer having an average particle diameter within the range shown above is preferred in that satisfactory polymerization stability is obtained in producing the thickening polymer and an emulsion having an appropriate viscosity is obtained. Furthermore, when an alkaline substance is added to an excavation stabilizing slurry containing the thickening agent of the present invention, which contains the alkali-thickening emulsion, the slurry thickens rapidly and comes to have an appropriate viscosity. Thus, an excavation stabilizing slurry having stable properties can be obtained.

Upon addition of an alkaline substance, the alkali-thickening emulsion contained in the thickening agent for excavation stabilizing slurries of the present invention rapidly thickens due to the dissolution or swelling of the thickening polymer. By suitably regulating the emulsion beforehand so as to have a given concentration, an aqueous polymer solution having a desired viscosity can be prepared.

Regardless of the production process used therefor, the alkali-thickening emulsion to be contained in the thickening agent for excavation stabilizing slurries of the present invention preferably is one having the following thickening characteristics. An aqueous solution prepared by diluting the emulsion to a solid content of 1% by mass has a viscosity of from 1 to 1,000 mPa·s, desirably from 1 to 500 mPa·s, more desirably from 1 to 100 mPa·s, and a solution prepared by adding an alkaline substance to the aqueous solution having a solid content regulated to 1% by mass to thereby adjust the pH thereof to 9 has a viscosity from 2 to 10,000 times, desirably from 2 to 8,000 times, more desirably from 2 to 5,000 times, the viscosity of the solution before the addition of the alkaline substance.

A clay mineral can be further incorporated into the excavation stabilizing slurry of the present invention at any desired time, e.g., during preparation of the excavation stabilizing slurry or just before use. With respect to alkaline substances and other additives including antifoamers, dispersants, CMC, surfactants, anti-dissipation materials, and the like, the excavation stabilizing slurry can exhibit sufficient performance even without these ingredients. However, these additives can be suitably incorporated as supplementary ingredients according to need. Water or the like may be incorporated likewise. As the additives including a clay mineral, alkaline substance, antifoamer, dispersant, and the like which can be incorporated into the excavation stabilizing slurry of the present invention, ones which have hitherto been used in excavation stabilizing slurries may be suitably used.

The clay mineral is an ingredient incorporated in order to give basic viscosity characteristics and fluid loss properties to the excavation stabilizing slurry. Examples thereof include sepiolite, attapulgite, ettringite, bentonite, kaolin clay, montmorillonite, cristobalite, hectorite, saponite, beidellite, zeolite, palygorskite, mica, and the like. These may be used alone or in combination of two or more thereof according to need. Preferred of these are sepiolite, attapulgite, ettringite, bentonite, kaolin clay, montmorillonite, cristobalite, and the like because they bring about high fluid loss properties. Especially preferred are bentonite, kaolin clay, and montmorillonite.

The alkaline substance is an additive which can be incorporated according to need. It may be incorporated in order to enhance the hydrophilicity of the thickening polymer and thereby enable the emulsion to thicken more rapidly. Examples thereof include sodium hydroxide, potassium hydroxide, sodium carbonate, sodium hydrogen carbonate, ammonium carbonate, ammonium hydrogen carbonate, ammonia (water solution), amines, and the like. These may be used alone or in combination of two or more thereof according to need.

The antifoamer also is an additive which can be incorporated according to need. Examples thereof include silicone antifoamers, Pluronic antifoamers, aliphatic alcohol antifoamers, fatty acid antifoamers, mineral oil antifoamers, tributyl phosphate antifoamers, and the like. These may be used alone or in combination of two or more thereof according to need. Since the excavation stabilizing slurry of the present invention has excellent low-bubbling properties which have been unobtainable hitherto as described above, it can be sufficiently handled even when it contains no antifoamer.

Furthermore, examples of the dispersant or the like include dispersants such as poly((meth)acrylic acid salt)s, ligninsulfonic acid salts, hexametaphosphates, tripolyphosphates, and the like; and additives such as water-soluble polymers including CMC, polyacrylamide, poly(vinyl alcohol), and the like.

In preparing the excavation stabilizing slurry of the present invention, the amounts of the constituent ingredients to be incorporated for constituting the excavation stabilizing slurry are not particularly limited. However, the amount of the thickening agent of the present invention to be incorporated, which contains an alkali-thickening emulsion, and the amount of a clay mineral to be incorporated are as follows. In 100 parts by mass of the excavation stabilizing slurry, the thickening agent amount is preferably from 0.01 to 20 parts by mass in terms of the solid components of the emulsion, and the clay mineral amount is preferably from 0 to 20 parts by mass. More preferably, the thickening agent amount is from 0.01 to 10 parts by mass in terms of the solid components of the emulsion, and the clay mineral amount is from 0.1 to 20 parts by mass. Even more preferably, the thickening agent amount is from 0.05 to 10 parts by mass in terms of the solid components of the emulsion, and the clay mineral amount is from 0.5 to 10 parts by mass. Especially preferably, the thickening agent amount is from 0.05 to 5 parts by mass in terms of the solid components of the emulsion, and the clay mineral amount is from 1 to 5 parts by mass. When the amount of the solid components of the emulsion is within the range shown above, the excavation stabilizing slurry has an appropriate viscosity and fluid loss properties and can be easily handled. However, amounts thereof exceeding, in particular, 20 parts by mass are undesirable in that there are cases where the viscosity of the excavation stabilizing slurry exceeds proper values and this prevents the separation of excavation soil and sand. On the other hand, the clay mineral amounts within the range shown above are preferred in that the excavation stabilizing slurry has an appropriate viscosity and fluid loss properties. In case where the amount of a clay mineral incorporated exceeds, in particular, 20 parts by mass, there is the possibility that the excavation stabilizing slurry might have too high a viscosity and be difficult to handle.

The amount of an alkaline substance to be incorporated is preferably such that the excavation stabilizing slurry comes to have a pH of 6 or higher, and is more preferably such that the excavation stabilizing slurry comes to have a pH of from 6 to 13. Amounts thereof regulated so as to result in an excavation stabilizing slurry pH of 6 or higher are preferred in that an appropriate viscosity can be given to the excavation stabilizing slurry. When the excavation stabilizing slurry has a pH of 13 or lower, the excavation stabilizing slurry has satisfactory fluid loss properties.

The amount of an antifoamer or the like to be incorporated may be suitably selected according to need as long as the fluid loss properties of the excavation stabilizing slurry are not reduced by the incorporation. However, the amount of an antifoamer to be incorporated is generally preferably 3 parts by mass or smaller, more preferably from 0.01 to 1 part by mass, per 100 parts by mass of the excavation stabilizing slurry. In case where the amount of the antifoamer incorporated exceeds 3 parts by mass, there is the possibility that the antifoamer might separate out or fluid loss properties might be reduced.

The amount of the water contained in the excavation stabilizing slurry of the present invention is not particularly limited. However, it is generally preferably from 80 to 99.9 parts by mass, more preferably from 90 to 99 parts by mass, per 100 parts by mass of the excavation stabilizing slurry. When the water amount is within that range, the excavation stabilizing slurry can retain an appropriate viscosity and fluid loss properties.

Methods for preparing the excavation stabilizing slurry of the present invention are not particularly limited. For example, the excavation stabilizing slurry can be easily obtained by mixing the constituent ingredients shown above, e.g., an alkaline substance, clay mineral, water, antifoamer, and the like, in any desired order with the thickening agent of the present invention, which contains an alkali-thickening emulsion.

The excavation stabilizing slurry of the present invention is suitable for use in excavation conducted by the diaphragm wall construction method or underground pile method for the purpose of preventing the wall face of a hole or the like formed by excavation from collapsing. Namely, when the diaphragm wall construction method or underground pile method, which is a method of excavation in which the ground is excavated while preventing the inner wall face of the excavation hole from collapsing, is applied using the excavation stabilizing slurry of the present invention, then excavation wall face collapsing can be prevented without fail.

In excavation by the diaphragm wall construction method or underground pile method using the excavation stabilizing slurry of the present invention, an excavation hole such as, e.g., a tunnel, is formed in the ground with a drill, a BW excavator, or an excavator such as a bucket type one, hydrophrase, or electromill and this excavation hole is filled with the excavation stabilizing slurry while thus forming the hole. As a result, the excavation stabilizing slurry infiltrates into the excavation wall, whereby a fluid loss mud wall layer called a mudcake is formed along the surface of the excavation wall. This mud wall layer has high fluid loss properties and reinforces the excavation wall, and the excavation stabilizing slurry has a hydraulic pressure higher than the pressure of the ground water. Consequently, the collapsing of the excavation hole inner wall face which is caused in the case where the hole depth exceeds the self-supporting height of the soil or caused by the hydraulic pressure of the ground water or another factor can be prevented. After the excavation stabilizing slurry of the present invention is used for excavation, the resultant spent excavation stabilizing slurry can be easily separated, before being discarded, into water and a solid matter by a dehydration treatment method used for the discard of excavation stabilizing slurries heretofore in use. The excavation stabilizing slurry containing the thickening agent of the present invention can be reused many times to diminish waste slurry treatment and is advantageous also from the standpoint of profitability.

When excavation is conducted under such conditions that the ground shows satisfactory self-supporting properties and use of water alone arouses no trouble in underground excavation, the thickening agent for excavation stabilizing slurries of the present invention alone may be added as the only excavation stabilizing slurry component to water or a combination of the thickening agent for excavation stabilizing slurries of the present invention and an alkaline substance may be added to water. In this case, the thickening agent is used for the purpose of preventing the excavation soil from adhering to the cutter head of the excavator or for another purpose.

### EXAMPLES

The present invention will be explained below in more detail by means of Examples and Comparative Examples, but the present invention should not be construed as being limited to the following Examples. Hereinafter, “%” means “% by mass” and “parts” means “parts by mass”.

### Emulsion Production Example 1

Into a flask equipped with a dropping funnel, stirrer, nitrogen introduction tube, thermometer, and condenser were placed 189.0 parts of ion-exchanged water, 9.8 parts of a 30% aqueous emulsifier solution (manufactured by Nippon Nyukazai Co., Ltd.; trade name, Newcol 707SF), and 11.7 parts of sodium styrenesulfonate. The atmosphere in the flask was replaced with nitrogen while stirring the contents at 75° C. A 52.6-part portion of a pre-emulsion separately obtained by agitating 164.3 parts of methacrylic acid, 117.4 parts of methyl acrylate, 9.8 parts of a 30% aqueous emulsifier solution (the same as above), and 460.5 parts of ion-exchanged water was introduced through the dropping funnel, and the resultant mixture was stirred for 5 minutes. Subsequently, 13.7 parts of 5% aqueous ammonium persulfate solution was introduced, and the contents were continuously stirred for 20 minutes while keeping the internal temperature at 75° C. to conduct initial polymerization. To the reaction mixture in the flask was added dropwise the remainder, i.e., 699.4 parts, of the pre-emulsion over 2 hours. After completion of the dropwise addition, the dropping funnel was rinsed with 10.1 parts of ion-exchanged water and the resultant rinsings were placed in the flask. The contents were continuously stirred for 30 minutes while keeping the internal temperature at 75° C. Thereafter, 13.7 parts of a 0.5% aqueous solution of sodium hydrogen sulfite as a catalyst for later addition was added and polymerization was conducted for further 60 minutes. The reaction mixture was cooled to terminate the polymerization. Thus, an emulsion (1) (nonvolatile concentration, 30.1%) containing a polymer (1) was obtained. The formulation is shown in Table 1.

### Emulsion Production Example 2

In a flask equipped with a dropping funnel, stirrer, nitrogen introduction tube, thermometer, and condenser were placed 192.7 parts of ion-exchanged water and 11.9 parts of sodium styrenesulfonate. The atmosphere in the flask was replaced with nitrogen. On the other hand, 179.4 parts of methacrylic acid and 107.6 parts of methyl acrylate were added to an aqueous emulsifier solution prepared by dissolving 1.0 part of a 30% aqueous emulsifier solution (manufactured by Nippon Nyukazai Co., Ltd.; trade name, Newcol 707SF) in 467.2 parts of ion-exchanged water, and this mixture was agitated to prepare a pre-emulsion. This pre-emulsion was placed in the dropping funnel. A 52.9-part portion of this pre-emulsion was placed in the flask, and the contents were heated to 75° C. with stirring. Subsequently, 2.0 parts of 1% aqueous β-mercaptopropionic acid solution was placed en bloc in the flask and 14.0 parts of 5% aqueous ammonium persulfate solution was then placed en bloc therein. The contents were continuously stirred for 20 minutes while keeping the internal temperature at 75° C. to conduct initial polymerization. To the reaction mixture in the flask was added dropwise the remainder, i.e., 702.3 parts, of the pre-emulsion over 3 hours. After completion of the dropwise addition, the dropping funnel was rinsed with 10.2 parts of ion-exchanged water and the resultant rinsings were placed in the flask. The contents were continuously stirred for 30 minutes while keeping the internal temperature at 75° C. Thereafter, 14.0 parts of a 0.5% aqueous solution of sodium hydrogen sulfite as a catalyst for later addition was added and polymerization was conducted for further 60 minutes. The reaction mixture was cooled to terminate the polymerization. Thus, an emulsion (2) (nonvolatile concentration, 29.9%) containing a polymer (2) was obtained. The formulation is shown in Table 1.

### Emulsion Production Example 3

In a flask equipped with a dropping funnel, stirrer, nitrogen introduction tube, thermometer, and reflux condenser were placed 239.3 parts of ion-exchanged water, 12.0 parts of sodium styrenesulfonate, 28.7 parts of methacrylic acid, and 0.1 part of a 30% aqueous emulsifier solution (manufactured by Nippon Nyukazai Co., Ltd.; trade name, Newcol 707SF). The contents were heated to 75° C. with stirring while replacing the atmosphere in the flask with nitrogen gas. On the other hand, 150.4 parts of methacrylic acid, 107.3 parts of methyl acrylate, and 0.5 parts of t-dodecyl mercaptan were added to an aqueous emulsifier solution prepared by dissolving 0.9 parts of a 30% aqueous emulsifier solution (manufactured by Nippon Nyukazai Co., Ltd.; trade name, Newcol 707SF) in 420.5 parts of ion-exchanged water, and this mixture was agitated to prepare a pre-emulsion.

Subsequently, 2.0 parts of 2% aqueous P-mercaptopropionic acid solution was placed en bloc in the flask and 14.0 parts of a 5% aqueous solution of ammonium persulfate as a polymerization initiator was then placed en bloc therein. The contents were stirred at 75° C. for 20 minutes to conduct initial polymerization. Thereafter, the pre-emulsion (679.6 parts) was added dropwise through the dropping funnel over 3 hours while keeping the reaction temperature at 75° C. After completion of the dropwise addition through the dropping funnel, the dropping funnel was rinsed with 10.3 parts of ion-exchanged water and the resultant rinsings were placed in the flask. After the reaction mixture was polymerized for further 30 minutes, 14.0 parts of 0.5% sodium hydrogen sulfite as a catalyst for later addition was added en bloc and polymerization was conducted for further 60 minutes. The liquid reaction mixture obtained was cooled to terminate the polymerization. Thus, an emulsion (3) (nonvolatile concentration, 30.1%) containing a polymer (3) was obtained. The formulation is shown in Table 1.

### Emulsion Production Example 4

In a flask equipped with a dropping funnel, stirrer, nitrogen introduction tube, thermometer, and reflux condenser were placed 239.3 parts of ion-exchanged water, 12.0 parts of sodium styrenesulfonate, 28.7 parts of methacrylic acid, and 0.1 part of a 30% aqueous emulsifier solution (manufactured by Nippon Nyukazai Co., Ltd.; trade name, Newcol 707SF). The contents were heated to 75° C. with stirring while replacing the atmosphere in the flask with nitrogen gas. On the other hand, 150.6 parts of methacrylic acid and 107.6 parts of methyl acrylate were added to an aqueous emulsifier solution prepared by dissolving 0.9 parts of a 30% aqueous emulsifier solution (manufactured by Nippon Nyukazai Co., Ltd.; trade name, Newcol 707SF) in 420.5 parts of ion-exchanged water, and this mixture was agitated to prepare a pre-emulsion.

Subsequently, 2.0 parts of 2% aqueous β-mercaptopropionic acid solution was placed en bloc in the flask and 14.0 parts of a 5% aqueous solution of ammonium persulfate as a polymerization initiator was then placed en bloc therein. The contents were stirred at 75° C. for 20 minutes to conduct initial polymerization. Thereafter, the pre-emulsion (679.6 parts) was added dropwise through the dropping funnel over 3 hours while keeping the reaction temperature at 75° C. After completion of the dropwise addition through the dropping funnel, the dropping funnel was rinsed with 10.3 parts of ion-exchanged water and the resultant rinsings were placed in the flask. After the reaction mixture was polymerized for further 30 minutes, 14.0 parts of 0.5% sodium hydrogen sulfite as a catalyst for later addition was added en bloc and polymerization was conducted for further 60 minutes. The liquid reaction mixture obtained was cooled to terminate the polymerization. Thus, an emulsion (4) (nonvolatile concentration, 30.0%) containing a polymer (4) was obtained. The formulation is shown in Table 1.

### Emulsion Production Example 5

In a flask equipped with a dropping funnel, stirrer, nitrogen introduction tube, thermometer, and reflux condenser were placed 239.3 parts of ion-exchanged water, 12.0 parts of sodium styrenesulfonate, 28.7 parts of methacrylic acid, and 0.1 part of a 30% aqueous emulsifier solution (manufactured by Nippon Nyukazai Co., Ltd.; trade name, Newcol 707SF). The contents were heated to 70° C. with stirring while replacing the atmosphere in the flask with nitrogen gas. On the other hand, 150.6 parts of methacrylic acid and 107.6 parts of methyl acrylate were added to an aqueous emulsifier solution prepared by dissolving 0.9 parts of a 30% aqueous emulsifier solution (manufactured by Nippon Nyukazai Co., Ltd.; trade name, Newcol 707SF) in 420.5 parts of ion-exchanged water, and this mixture was agitated to prepare a pre-emulsion.

Subsequently, 2.0 parts of 2% aqueous P-mercaptopropionic acid solution was placed en bloc in the flask and 14.0 parts of a 5% aqueous solution of ammonium persulfate as a polymerization initiator was then placed en bloc therein. The contents were stirred at 70° C. for 20 minutes to conduct initial polymerization. Thereafter, the pre-emulsion (679.6 parts) was added dropwise through the dropping funnel over 4 hours while keeping the reaction temperature at 70° C. After completion of the dropwise addition through the dropping funnel, the dropping funnel was rinsed with 10.3 parts of ion-exchanged water and the resultant rinsings were placed in the flask. After the reaction mixture was polymerized for further 30 minutes, 14.0 parts of 0.5% sodium hydrogen sulfite as a catalyst for later addition was added en bloc. The reaction temperature was elevated to 80° C. and polymerization was conducted for further 60 minutes. The liquid reaction mixture obtained was cooled to terminate the polymerization. Thus, an emulsion (5) (nonvolatile concentration, 29.8%) containing a polymer (5) was obtained. The formulation is shown in Table 1.

### Emulsion Production Example 6

In a flask equipped with two dropping funnels, a stirrer, nitrogen introduction tube, thermometer, and condenser were placed 326.1 parts of ion-exchanged water and 2.9 parts of Hitenol N-08 (trade name; manufactured by Dai-ichi Kogyo Seiyaku Co., Ltd.). The Hitenol N-08 was completely dissolved while stirring the contents at 75° C. The atmosphere in the flask was replaced with nitrogen while keeping the aqueous solution containing Hitenol N-08 at 75° C. Thereafter, a 57.4-part portion of a pre-emulsion separately obtained by stirring 102.2 parts of methacrylic acid, 189.8 parts of methyl acrylate, 5.8 parts of Hitenol N-08, and 276.2 parts of ion-exchanged water was placed therein through a dropping funnel, and this mixture was stirred for 5 minutes. Subsequently, 3 parts of 1% aqueous sodium hydrogen sulfite solution and 6.7 parts of 1% aqueous ammonium persulfate solution were introduced. The contents were stirred for 20 minutes while keeping the internal temperature at 75° C. to conduct initial polymerization. To the reaction mixture in the flask were added dropwise the remainder, i.e., 516.6 parts, of the pre-emulsion and 60.3 parts of 1% aqueous ammonium persulfate solution over 2 hours and 3 hours, respectively. After completion of the dropwise addition, the dropping funnels were rinsed with 10.0 parts of ion-exchanged water and the resultant rinsings were placed in the flask. After the contents were continuously stirred for 30 minutes while keeping the internal temperature at 75° C., 17.0 parts of a 1.0% aqueous solution of Rongalit as a catalyst for later addition was added dropwise over 30 minutes and polymerization was conducted for further 30 minutes. The reaction mixture was cooled to terminate the polymerization. Thus, an emulsion (6) (nonvolatile concentration, 29.6%) containing a polymer (6) was obtained. The formulation is shown in Table 1.

### Emulsion Production Example 7

In a flask equipped with two dropping funnels, a stirrer, nitrogen introduction tube, thermometer, and condenser were placed 336.1 parts of ion-exchanged water and 4.4 parts of Hitenol N-08 (trade name; manufactured by Dai-ichi Kogyo Seiyaku Co., Ltd.). The Hitenol N-08 was completely dissolved while stirring the contents at 68° C. The atmosphere in the flask was replaced with nitrogen while stirring the aqueous solution containing Hitenol N-08. Thereafter, a 28.2-part portion of a pre-emulsion separately obtained by stirring 174.2 parts of methacrylic acid, 116.2 parts of ethyl acrylate, 4.4 parts of Hitenol N-08, and 269.1 parts of ion-exchanged water was introduced through a dropping funnel, and this mixture was stirred for 5 minutes while keeping it at 72° C. Subsequently, 1 part of 5% aqueous sodium hydrogen sulfite solution and 3.4 parts of 1% aqueous ammonium persulfate solution were introduced. The contents were stirred for 20 minutes while keeping the internal temperature at 72° C. to conduct initial polymerization. To the reaction mixture in the flask were added dropwise the remainder, i.e., 535.7 parts, of the pre-emulsion and 64.7 parts of 1% aqueous ammonium persulfate solution over 2 hours each. After completion of the dropwise addition, the dropping funnels were rinsed with 26.5 parts of ion-exchanged water and the resultant rinsings were placed in the flask. The contents were continuously stirred for 1 hour while keeping the internal temperature at 72° C. The reaction mixture was cooled to terminate the polymerization. Thus, an emulsion (7) (nonvolatile concentration, 29.4%) containing a polymer (7) was obtained. The formulation is shown in Table 1.

TABLE 1

| | | Nonionic | |
|---|---|---|---|
| | | polymerizable | |
| | Carboxyl- | monomer having | |
| | containing | solubility in 20° C. | Other |
| | polymerizable | water of 3% or | copolymerizable |
| | monomer | higher | monomer |
| Emulsion (1) | MAA 56% | MA 40% | NaSS 4% |
| Emulsion (2) | MAA 60% | MA 36% | NaSS 4% |
| Emulsion (3) | MAA 60% | MA 36% | NaSS 4% |
| Emulsion (4) | MAA 60% | MA 36% | NaSS 4% |
| Emulsion (5) | MAA 60% | MA 36% | NaSS 4% |
| Emulsion (6) | MAA 35% | MA 65% | — |
| Emulsion (7) | MAA 60% | — | EA 40% |

MAA: methacrylic acid
MA: methyl acrylate
EA: ethyl acrylate
NaSS: sodium p-styrenesulfonate

### Example 1

Emulsion (1) obtained in Production Example 1 given above was mixed with ion-exchanged water and 0.5N aqueous NaOH solution to obtain an aqueous solution regulated so that the content of the solid components (nonvolatile matter) of the emulsion was 0.2% based on the total amount and the pH was 8.0±0.1. In a 1 liter beaker made of stainless steel was placed 250.0 g of this aqueous solution. Thereto was added 50.0 g of JIS test powders I, Class 7 (Kanto loam, fine grain; manufactured by the Association of Powder Process Industry and Engineering, Japan). This mixture was agitated with Disper at a rotational speed of 8,000 rpm for 3 minutes while being kept at 20° C. to obtain a solid-containing liquid (1a). This liquid was placed in a 200 ml measuring cylinder made of glass to measure the apparent specific gravity just after the strong agitation. After 10 minutes, 0.1 g of an antifoamer (Aqualen 3062; manufactured by Kyoeisha Chemical Co., Ltd.) was added to destroy the bubbles present on the top and the apparent specific gravity was measured. The results are shown in Table 2 (average value for three tests).

### Example 2

The same procedure as in Example 1 was conducted, except that emulsion (2) was used in place of emulsion (1) in Example 1. Thus, a solid-containing liquid (2a) was obtained. The apparent specific gravity of this liquid was measured just after strong agitation and at 10 minutes thereafter in the same manner as in Example 1. The results are shown in Table 2 (average value for three tests).

### Example 3

The same procedure as in Example 1 was conducted, except that emulsion (3) was used in place of emulsion (1) in Example 1. Thus, a solid-containing liquid (3a) was obtained. The apparent specific gravity of this liquid was measured just after strong agitation and at 10 minutes thereafter in the same manner as in Example 1. The results are shown in Table 2 (average value for three tests).

### Example 4

The same procedure as in Example 1 was conducted, except that emulsion (4) was used in place of emulsion (1) in Example 1. Thus, a solid-containing liquid (4a) was obtained. The apparent specific gravity of this liquid was measured just after strong agitation and at 10 minutes thereafter in the same manner as in Example 1. The results are shown in Table 2 (average value for three tests).

### Example 5

The same procedure as in Example 1 was conducted, except that emulsion (5) was used in place of emulsion (1) in Example 1. Thus, a solid-containing liquid (5a) was obtained. The apparent specific gravity of this liquid was measured just after strong agitation and at 10 minutes thereafter in the same manner as in Example 1. The results are shown in Table 2 (average value for three tests).

### Comparative Example 1

The same procedure as in Example 1 was conducted, except that emulsion (6) was used in place of emulsion (1) in Example 1. Thus, a solid-containing liquid (6a) was obtained. The apparent specific gravity of this liquid was measured just after strong agitation and at 10 minutes thereafter in the same manner as in Example 1. The results are shown in Table 2 (average value for three tests).

### Comparative Example 2

The same procedure as in Example 1 was conducted, except that emulsion (7) was used in place of emulsion (1) in Example 1. Thus, a solid-containing liquid (7a) was obtained. The apparent specific gravity of this liquid was measured just after strong agitation and at 10 minutes thereafter in the same manner as in Example 1. The results are shown in Table 2 (average value for three tests).

TABLE 2

| | | Specific gravity of | Specific gravity of |
|---|---|---|---|
| | | liquid immediately | liquid at 10 minutes |
| | | after strong | after strong |
| | Emulsion | agitation (g/ml) | agitation (g/ml) |
| Example 1 | (1) | 1.060 | 1.110 |
| (1a) | | | |
| Example 2 | (2) | 1.101 | 1.111 |
| (2a) | | | |
| Example 3 | (3) | 1.103 | 1.106 |
| (3a) | | | |
| Example 4 | (4) | 1.084 | 1.107 |
| (4a) | | | |
| Example 5 | (5) | 1.080 | 1.103 |
| (5a) | | | |
| Comparative | (6) | 0.922 | 1.078 |
| Example 1 | | | |
| (6a) | | | |
| Comparative | (7) | 0.931 | 1.082 |
| Example 2 | | | |
| (7a) | | | |

### Example 6

Emulsion (1) obtained in Production Example 1 given above was placed in a stainless-steel cup in such a weighed amount that polymer (1) accounted for 0.2% of a total amount, and ion-exchanged water was added thereto to adjust the total amount to 600 g.

Subsequently, bentonite (Asama-jirushi) was added in an amount of 3% based on the total amount. While the mixture was kept being stirred with a Hamilton beach mixer at a rotational speed of 1,200 rpm, anhydrous sodium carbonate was added in an amount of 0.14% based on the total amount. The stirring was conducted for 30 minutes. The resultant dispersion was allowed to stand for 24 hours and then stirred with the Hamilton Beech Mixer again for 5 minutes to obtain an excavation stabilizing slurry (1b). In preparing this excavation stabilizing slurry, very little bubbling occurred during the stirring and the slurry could be prepared stably and satisfactorily. This excavation stabilizing slurry was examined for funnel viscosity and water loss by methods according to the following test methods provided for by American Petroleum Institute (API). The results are shown in Table 3.

[Method of Measuring Funnel Viscosity]

In a funnel viscometer, which has a funnel shape, is placed 500 ml of an excavation stabilizing slurry. The time required for the whole slurry to flow out is measured.

[Method of Measuring Water Loss]

In the cylinder of a water loss measuring equipment is placed 290 ml of an excavation stabilizing slurry. Toyo Filter Paper No. 4 having a diameter of 9 cm is placed, and a cap having a drain is set. The cylinder is fixed in a given position and a measuring cylinder is set. Thereafter, the inside of the cylinder is pressurized to 3 kg/cm² with a nitrogen bomb and the amount of water (ml) flowing out in 30 minutes is measured with the measuring cylinder.

### Example 7

The same procedure as in Example 6 was conducted, except that emulsion (2) was used in place of emulsion (1) in Example 6. Thus, an excavation stabilizing slurry (2b) was obtained. In preparing this excavation stabilizing slurry, very little bubbling occurred during the stirring and the slurry could be prepared stably and satisfactorily. This excavation stabilizing slurry was examined for funnel viscosity and water loss. The results are shown in Table 3.

### Example 8

The same procedure as in Example 3 was conducted, except that emulsion (4) was used in place of emulsion (1) in Example 6. Thus, an excavation stabilizing slurry (4b) was obtained. In preparing this excavation stabilizing slurry, very little bubbling occurred during the stirring and the slurry could be prepared stably and satisfactorily. This excavation stabilizing slurry was examined for funnel viscosity and water loss. The results are shown in Table 3.

### Comparative Example 3

The same procedure as in Example 6 was conducted, except that emulsion (6) was used in place of emulsion (1) in Example 6. Thus, an excavation stabilizing slurry was prepared. As a result, considerable bubbling occurred during the stirring and the excavation stabilizing slurry overflowed the stainless-steel cup and could not be stably prepared.

### Comparative Example 4

The same procedure as in Example 6 was conducted, except that emulsion (6) was used in place of emulsion (1) in Example 6 and ion-exchanged water was added to the emulsion (6) to adjust the total amount to 600 g, and that Aqualen 3062 (trade name; manufactured by Kyoeisha Chemical Co., Ltd.), which is a silicone antifoamer, was added in an amount of 0.1% based on the total amount. Thus, an excavation stabilizing slurry (6b) was obtained. This excavation stabilizing slurry was examined for funnel viscosity and water loss. The results are shown in Table 3.

Table 3

TABLE 3

| | | Funnel viscosity | Water loss |
|---|---|---|---|
| | Emulsion | (sec) | (ml) |
| Example 6 | (1) | 27.8 | 8.7 |
| (1b) | | | |
| Example 7 | (2) | 28.4 | 8.8 |
| (2b) | | | |
| Example 8 | (4) | 28.2 | 8.9 |
| (4b) | | | |
| Comparative | (6) | 26.5 | 9.6 |
| Example 4 | | | |
| (6b) | | | |

### Example 9 and Comparative Example 5

Excavation stabilizing slurries A, B, and C of the present invention containing emulsions (3), (4), and (5) and excavation stabilizing slurries a, b, and c having compositions heretofore in use were prepared according to the respective excavation stabilizing slurry formulations shown in Table 4. These excavation stabilizing slurries were compared in the degree of excavation soil contamination thereinto during excavation.

With respect to emulsions (3), (4), and (5), the weight-average molecular weights of polymers (3), (4), and (5) were determined by a method in which each emulsion was dissolved in tetrahydrofuran so as to result in a solid content of 0.15% and the solution was analyzed by gel permeation chromatography (GPC) to determine the molecular weight using a calibration curve obtained with polystyrene. The results are given below.

Polymer (3) in emulsion (3): molecular weight, 300,000.

Polymer (4) in emulsion (4): molecular weight, 800,000.

Polymer (5) in emulsion (5): molecular weight, 1,200,000.

TABLE 4

| Kind of slurry | | Components of slurry (mass %) |
|---|---|---|
| Example 9 | Slurry A | Hojun bentonite (Asama), 3%; emulsion (3), |
| | | 0.8%; sodium carbonate, 0.1% |
| | Slurry B | Hojun bentonite (Asama), 3%; emulsion (4), |
| | | 0.6%; sodium carbonate, 0.1% |
| | Slurry C | Hojun bentonite (Asama), 3%; emulsion (5), |
| | | 0.2%; sodium carbonate, 0.1% |
| Comparative | Slurry a | Hojun bentonite (Asama), 3%; CMC, |
| Example 5 | | 0.3%; sodium carbonate, 0.1% |
| | Slurry b | Hojun bentonite (Asama), 3%; CMC, 0.3% |
| | Slurry c | Hojun bentonite (Asama), 3%; CMC, 0.3%; |
| | | poly(sodium acrylate), 0.1% |

The degree of excavation soil contamination into the excavation stabilizing slurries was determined by the following method.

To 30 liters of each of the slurries A, B, and C of the present invention and the slurries a, b, and c having compositions heretofore in use, which are shown in Table 4, was added 20% silty clay (water content, 45% by mass) collected in an excavation field. The resulting mixture was stirred with a Labo Stirrer (+75 mm×4-blade impeller; rotational speed, 700 rpm) for 30 minutes and then centrifuged with a centrifugal separator (centrifugal effect: G=200) for 1 minute. Thereafter, the supernatant of the excavation stabilizing slurry was taken out and examined for specific gravity, funnel viscosity (FV), and water loss (WL). Furthermore, the supernatant taken out of the excavation stabilizing slurry was repeatedly subjected eight times to the silty-clay addition test in the same manner (9 times in total) to examine the behavior.

TABLE 5

| | | | Number of excavation soil additions | | | | | | | | | |
|---|---|---|---|---|---|---|---|---|---|---|---|---|
| Test slurry | | Properties | 0 | 1 | 2 | 3 | 4 | 5 | 6 | 7 | 8 | 9 |
| Example 9 | Slurry A | Specific | 1.019 | 1.030 | 1.039 | 1.052 | 1.065 | 1.078 | 1.090 | 1.112 | 1.116 | 1.130 |
| | | gravity | | | | | | | | | | |
| | | (g/ml) | | | | | | | | | | |
| | | FV (sec) | 26.3 | 27.5 | 28.0 | 28.9 | 29.7 | 31.0 | 32.0 | 32.8 | 35.0 | 36.7 |
| | | WL (ml) | 8.9 | 9.2 | 9.8 | 10.5 | 11.0 | 11.9 | 13.0 | 14.3 | 15.5 | 16.9 |
| | Slurry B | Specific | 1.020 | 1.027 | 1.036 | 1.047 | 1.059 | 1.070 | 1.085 | 1.098 | 1.108 | 1.113 |
| | | gravity | | | | | | | | | | |
| | | (g/ml) | | | | | | | | | | |
| | | FV (sec) | 26.6 | 27.3 | 27.9 | 28.5 | 29.0 | 29.8 | 30.9 | 32.4 | 33.9 | 35.3 |
| | | WL (ml) | 8.2 | 8.7 | 8.5 | 9.2 | 9.8 | 10.2 | 11.0 | 11.2 | 12.6 | 13.9 |
| | Slurry C | Specific | 1.022 | 1.025 | 1.034 | 1.043 | 1.052 | 1.066 | 1.080 | 1.095 | 1.106 | 1.115 |
| | | gravity | | | | | | | | | | |
| | | (g/ml) | | | | | | | | | | |
| | | FV (sec) | 27.0 | 28.0 | 28.4 | 29.0 | 29.8 | 30.8 | 31.5 | 33.1 | 35.0 | 36.0 |
| | | WL(ml) | 8.0 | 8.4 | 8.2 | 8.9 | 9.3 | 9.9 | 10.6 | 11.2 | 12.8 | 13.6 |
| Comparative | Slurry a | Specific | 1.021 | 1.037 | 1.050 | 1.062 | 1.089 | 1.112 | 1.123 | 1.139 | 1.159 | 1.180 |
| Example 5 | | gravity | | | | | | | | | | |
| | | (g/ml) | | | | | | | | | | |
| | | FV (sec) | 26.7 | 28.0 | 29.7 | 30.7 | 34.2 | 37.5 | 37.0 | 35.0 | 33.4 | 32.0 |
| | | WL (ml) | 10.8 | 11.3 | 11.9 | 13.0 | 14.2 | 15.0 | 16.2 | 17.5 | 18.8 | 19.4 |
| | Slurry b | Specific | 1.020 | 1.039 | 1.048 | 1.060 | 1.082 | 1.105 | 1.117 | 1.129 | 1.148 | 1.165 |
| | | gravity | | | | | | | | | | |
| | | (g/ml) | | | | | | | | | | |
| | | FV (sec) | 27.0 | 28.6 | 29.7 | 30.2 | 33.7 | 36.5 | 34.0 | 33.2 | 32.0 | 30.8 |
| | | WL (ml) | 10.6 | 11.0 | 12.2 | 12.9 | 14.0 | 15.1 | 15.9 | 17.0 | 17.6 | 18.8 |
| | Slurry c | Specific | 1.019 | 1.035 | 1.046 | 1.062 | 1.080 | 1.107 | 1.115 | 1.130 | 1.142 | 1.160 |
| | | gravity | | | | | | | | | | |
| | | (g/ml) | | | | | | | | | | |
| | | FV (sec) | 26.4 | 27.5 | 29.0 | 30.5 | 34.0 | 37.0 | 36.2 | 35.0 | 33.0 | 32.0 |
| | | WL (ml) | 10.0 | 11.0 | 12.3 | 13.4 | 13.9 | 15.7 | 16.5 | 17.0 | 18.2 | 19.0 |

As apparent from the results given in Table 5, the slurries A, B, and C of the present invention are more effective in separating the silty clay than the slurries a, b, and c heretofore in use, and undergo a smaller increase in specific gravity with repetitions of addition. The degree of increase in water loss (WL) also is low. This indicates that the emulsion polymer is adsorbed onto the surface of the silty clay which has contaminated the excavation stabilizing slurry and facilitates the separation and removal thereof from the excavation stabilizing slurry based on the protective-colloid effect (polymer covering effect).

### Example 10 and Comparative Example 6

Excavation stabilizing slurries D and E of the present invention containing emulsion (4) and slurries d and e having compositions heretofore in use were prepared according to the respective excavation stabilizing slurry formulations shown in Table 6. These slurries were compared in the degree of quality deterioration caused by the influence of cement components contaminating thereinto during excavation.

TABLE 6

| Kind of slurry | | Components of slurry (wt %) |
|---|---|---|
| Example 10 | Slurry D | Hojun bentonite (Asama), 3%; emulsion (4), |
| | | 0.6% |
| | Slurry E | Hojun bentonite (Asama), 3%; emulsion (4), |
| | | 0.6%; silty clay, 10% |
| Comparative | Slurry d | Hojun bentonite (Asama), 3%; CMC, 0.3% |
| Example 6 | Slurry e | Hojun bentonite (Asama), 3%; CMC, 0.3%; |
| | | silty clay, 10% |

The degree of quality deterioration caused by the influence of cement components on the excavation stabilizing slurries was determined by the following method. A cement slurry which contained 0.5 g/ml normal portland cement and had been continuously stirred for 24 hours was added to 1 liter of each of the slurries D and E of the present invention and the slurries d and e having compositions heretofore in use, which are shown in Table 6, in amounts of 1%, 2%, and 3% in terms of solid cement weight. Each resultant mixture was stirred with a Labo Stirrer (φ45 mm×4-blade impeller; rotational speed, 700 rpm) for 10 minutes. Thereafter, the mixture was examined for funnel viscosity (FV), apparent viscosity (BV), and water loss (WL) to examine the degree of quality deterioration of the excavation stabilizing slurry.

TABLE 7

| | | | Amount of cement | | | |
|---|---|---|---|---|---|---|
| | | | added (%) | | | |
| Test slurry | | Properties | 0 | 1 | 2 | 3 |
| Example | Slurry D | FV (sec) | 25.4 | 24.3 | 23.5 | 23.0 |
| 10 | | BV (mPa · s) | 16.0 | 12.0 | 10.0 | 9.0 |
| | | WL (ml) | 10.2 | 12.2 | 12.0 | 12.4 |
| | Slurry E | FV (sec) | 28.4 | 25.1 | 25.3 | 25.2 |
| | | BV (mPa · s) | 34.0 | 35.8 | 37.0 | 41.0 |
| | | WL (ml) | 11.4 | 12.8 | 13.2 | 14.0 |
| Comparative | Slurry d | FV (sec) | 31.6 | 29.1 | 26.4 | 28.5 |
| Example 6 | | BV (mPa · s) | 54.5 | 26.0 | 27.8 | 39.0 |
| | | WL (ml) | 11.4 | 12.0 | 36.9 | 92.0 |
| | Slurry e | FV (sec) | 32.5 | 34.6 | 39.5 | 51.3 |
| | | BV (mPa · s) | 51.5 | 48.0 | 12.0 | 150 |
| | | WL (ml) | 12.0 | 24.2 | 48.0 | 120 |

The results given in Table 7 clearly show that the excavation stabilizing slurries D and E of the present invention have a far lower degree of quality deterioration by cement contamination than the excavation stabilizing slurries d and e having compositions heretofore in use.

### Example 11 and Comparative Example 7

An excavation stabilizing slurry F of the present invention containing emulsion (4) and an excavation stabilizing slurry f having a composition heretofore in use were prepared according to the respective excavation stabilizing slurry formulations shown in Table 8. These excavation stabilizing slurries were compared in the degree of quality deterioration caused by microorganisms present in the excavation soil during excavation.

TABLE 8

| Kind of slurry | | Components of slurry (mass %) |
|---|---|---|
| Example 11 | Slurry F | Hojun bentonite (Asama), 3%; emulsion (4), |
| | | 0.6% |
| Comparative | Slurry f | Hojun bentonite (Asama), 3%; CMC, 0.3% |
| Example 7 | | |

The degree of quality deterioration caused by the influence of microorganisms on the excavation stabilizing slurries was determined by the following method. A culture medium was added in an amount of 2% to 1 liter of each of the excavation stabilizing slurry F of the present invention and the excavation stabilizing slurry f having a composition heretofore in use, which are shown in Table 8. While each excavation stabilizing slurry was kept being aged in a 37° C. thermostatic chamber, it was sampled at intervals of given days and examined for funnel viscosity (FV), apparent viscosity (BV), and water loss (WL). Thus, the quality behavior of each excavation stabilizing slurry was examined over 90 days.

Incidentally, the culture medium was prepared by adding 46 parts of water to 100 parts of silty clay, adding guar gum thereto in an amount of 0.5 parts per the water, mixing these ingredients together, and aging the resulting mixture in a 37° C. thermostatic chamber for 5 days.

TABLE 9

| | | | Number of days for aging (day) | | | | | | |
|---|---|---|---|---|---|---|---|---|---|
| Test slurry | | Properties | 0 | 3 | 7 | 14 | 30 | 60 | 90 |
| Example | Slurry F | FV (sec) | 26.1 | 28.6 | 28.9 | 29.1 | 29.5 | 29.4 | 29.6 |
| 11 | | BV (mPa · s) | 12.5 | 18.6 | 20.5 | 22.0 | 24.5 | 28.0 | 28.5 |
| | | WL (ml) | 11.0 | 9.8 | 10.6 | 10.8 | 10.8 | 9.8 | 10.0 |
| Comparative | Slurry f | FV (sec) | 28.0 | 30.5 | 28.4 | 26.0 | 25.2 | 24.5 | 24.0 |
| Example 7 | | BV (mPa · s) | 35.0 | 40.0 | 39.0 | 23.0 | 20.6 | 17.7 | 16.0 |
| | | WL (ml) | 11.4 | 11.6 | 11.8 | 12.3 | 15.3 | 18.0 | 23.6 |

As apparent from the results given in Table 9, a comparison between the slurry F of the present invention and the slurry f having a composition heretofore in use shows the following. The excavation stabilizing slurry of the present invention tends to increase in funnel viscosity and apparent viscosity and is almost constant in water loss. The excavation stabilizing slurry having a composition heretofore in use tends to decrease in fimnel viscosity and apparent viscosity and increases in water loss. These behaviors in the time period indicate that the excavation stabilizing slurry of the present invention is reduced in biochemical quality deterioration caused by microorganisms. This indicates that as compared with CMC, which is based on natural cellulose, the thickening agent of the present invention, which contains an alkali-thickening emulsion, is less susceptible to the influence of hydrolases which generate with the growth of microorganisms present in the excavation soil, because it is based on a synthetic polymeric agent.

Even when an excavation soil contaminates underground excavation stabilizing slurries containing the thickening agent of the present invention, which contains as alkali-thickening emulsion, the soil can be effectively separated and the increase in the specific gravity of the slurries is little. Furthermore, the excavation stabilizing slurries are less susceptible to quality deterioration by cement contamination and to biochemical quality deterioration by microorganisms. The excavation stabilizing slurries can be repeatedly used to attain an improved degree of reuse.

### Example 12

An excavation stabilizing slurry containing a thickening agent of the present invention, which contained an alkali-thickening emulsion, was used in a certain field of cast-in-place pile construction. The results thereof will be described below. Table 10 shows an outline of the construction, and Table 11 shows the components of the slurry containing a thickening agent of the present invention, which contained an alkali-thickening emulsion.

TABLE 10

| | | |
|---|---|---|
| Kind of pile | Expansion piles: | |
| | diameter 1,300 × 2,200 | (5 piles) |
| | diameter 1,300 × 2,000 | (2 piles) |
| | diameter 1,300 × 1,800 | (5 piles) |
| | diameter 1,300 × 1,600 | (6 piles) |
| | Straight piles: | |
| | diameter 1,300 | (5 piles) |
| | diameter 1,000 | (7 piles) |
| | Total: | 30 piles |

| | |
|---|---|
| Depth of excavation (m) | 19.0 |
| Amount of soil excavated (m³) | 703 |
| Soil | clay, clayey silt, silty fine sand |
| Excavation method | cast-in-place pile method with |
| | earth drill excavator |

TABLE 11

| Materials for slurry | Components of slurry (mass %) |
|---|---|
| Bentonite (Kunigel V1) from Yamagata | 2.0 |
| Emulsion (4) | 0.4 |
| Sodium carbonate | 0.1 |

The excavation stabilizing slurry containing a thickening agent of the present invention, which contained an alkali-thickening emulsion, was prepared by introducing the materials for the excavation stabilizing slurry into a 20 m³ preparation tank with a suction pump and stirring the mixture by pump circulation. The excavation stabilizing slurry thus prepared, which contained the thickening agent of the present invention containing an alkali-thickening emulsion, was transferred to a circulation tank, and excavation was conducted to the predetermined depth while the excavation hole was kept being filled with the slurry with a pump. After completion of the excavation, a reinforcing-bar cage was installed in the hole. A tremie pipe was inserted into the hole and concrete was placed. The excavation stabilizing slurry with which the hole had been filled was recovered and put in a 20 m³ tank. The excavation stabilizing slurry recovered was transferred successively to a 25 m³ circulation tank and a 30 m³ circulation tank, and used for the excavation for the next pile.

The quality of the excavation stabilizing slurry, which contained the thickening agent of the present invention containing an alkali-thickening emulsion, was examined by sampling the slurry at the feed opening through which the excavation stabilizing slurry was sent from the circulation tank for filling an excavation hole and by measuring the specific gravity, sand content, funnel viscosity, and water loss thereof. The quality of the excavation stabilizing slurry, which contained the thickening agent of the present invention containing an alkali-thickening emulsion, is shown in Table 12.

TABLE 12

Quality of excavation stabilizing slurry

| Order of pile | | Sand | Funnel | |
|---|---|---|---|---|
| excavation | Specific | content | viscosity | Water loss |
| (-th pile) | gravity | (%) | (sec) | (ml) |
| 0 | 1.010 | 0 | 22.71 | 13.0 |
| 1 | 1.028 | 0.4 | 20.44 | 18.0 |
| 2 | 1.023 | 0.4 | 21.54 | 15.8 |
| 3 | 1.033 | 0.3 | 21.94 | 19.0 |
| 4 | 1.025 | 0.1 | 23.18 | 12.5 |
| 5 | 1.028 | 0.2 | 23.30 | 15.4 |
| 6 | 1.031 | 0.1 | 24.59 | 13.4 |
| 7 | 1.030 | 0.2 | 25.22 | 13.5 |
| 8 | 1.034 | 0.3 | 24.34 | 16.1 |
| 9 | 1.034 | 0.7 | 24.50 | 17.1 |
| 10 | 1.031 | 0.3 | 23.09 | 15.3 |
| 11 | 1.033 | 0.2 | 22.92 | 17.6 |
| 12 | 1.033 | 0.1 | 23.83 | 16.5 |
| 13 | 1.035 | 0.1 | 23.49 | 19.8 |
| 14 | 1.043 | 0.2 | 23.32 | 22.4 |
| 15 | 1.039 | 0.2 | 23.10 | 21.2 |
| 16 | 1.040 | 0.1 | 23.00 | 22.7 |
| 17 | 1.039 | 0.3 | 22.59 | 23.9 |
| 18 | 1.039 | 0.2 | 22.77 | 20.2 |
| 19 | 1.045 | 0.7 | 23.20 | 22.1 |
| 20 | 1.044 | 0.7 | 22.70 | 22.3 |
| 21 | 1.048 | 0.8 | 22.88 | 22.6 |
| 22 | 1.042 | 0.7 | 23.23 | 19.6 |
| 23 | 1.045 | 0.3 | 23.85 | 22.6 |
| 24 | 1.057 | 1.2 | 24.82 | 27.4 |
| 25 | 1.035 | 0.1 | 23.00 | 17.9 |
| 26 | 1.038 | 0.1 | 23.08 | 18.9 |
| 27 | 1.039 | 0.2 | 22.67 | 21.8 |
| 28 | 1.038 | 0.4 | 22.78 | 19.5 |
| 29 | 1.030 | 0.1 | 22.28 | 19.0 |
| 30 | 1.034 | 0.1 | 23.07 | 19.8 |

As apparent from the results given in Table 12, when the thickening agent of the present invention, which contained an alkali-thickening emulsion, was used in an actual construction field, the repetitions of use of the excavation stabilizing slurry did not result in a considerable increase in specific gravity, sand content, funnel viscosity, or water loss and the excavation stabilizing slurry had satisfactory quality.

Furthermore, the excavation soil which had contaminated the excavation stabilizing slurry satisfactorily sedimented and the dredging, which is an operation conducted on the termination of excavation, could be easily performed. The amount of the sand contained in the excavation stabilizing slurry recovered in concrete placing was as small as 1% or less.

The total amount of the excavation stabilizing slurry of the present invention prepared was 175 m³ in contrast to the total excavation soil amount of 703 m³, and the degree of reuse, which is an index to the suitability of an excavation stabilizing slurry for repetitions of use, was as high as 4.0. The excavation could be completed with such a high degree of reuse.

### Example 13

An excavation stabilizing slurry containing a thickening agent of the present invention, which contained an alkali-thickening emulsion, was used in a certain field of diaphragm wall construction method. The results thereof will be described below. Table 13 shows an outline of the construction, and Table 14 shows the components of the slurry containing a thickening agent of the present invention, which contained an alkali-thickening emulsion.

TABLE 13

| | |
|---|---|
| Depth of excavation (m) | 63.0 |
| Wall thickness (mm) | 1,800 |
| Element length (m) | 2.4 |
| Number of elements | 24 |
| Amount of soil excavated (m³) | 7,330 |
| Soil | clay, silt, sandy silt, gravel, fine sand, |
| | mudstone |
| Excavation method | diaphragm method with excavator |
| | Electromill 240 |

TABLE 14

| Materials for slurry | Components of slurry (mass %) |
|---|---|
| Hojun bentonite (Asama) | 2.0 |
| Emulsion (4) | 0.8 |
| Sodium carbonate | 0.1 |

The excavation stabilizing slurry containing a thickening agent of the present invention, which contained an alkali-thickening emulsion, was prepared by introducing the materials for the excavation stabilizing slurry with a 6 m³ suction type jet mixer and stirring the mixture with a mixing pump. The slurry thus prepared, which contained the thickening agent of the present invention containing an alkali-thickening emulsion, was transferred to a 230 m³ circulation tank, and excavation was conducted to the predetermined depth while the excavation trench was kept being filled with the slurry with a pump. After completion of the excavation, the excavation trench was dredged and a reinforcing-bar cage was installed in the trench. A tremie pipe was inserted into the trench and concrete was placed. The excavation stabilizing slurry with which the trench had been filled was recovered and put in a 230 m³ recovery tank. The excavation stabilizing slurry recovered was treated with a soil-and-sand separator (sand screen and cyclone) and a superdecanter to remove the excavation soil and sand which had contaminated the excavation stabilizing slurry. Thereafter, the excavation stabilizing slurry was used for excavation for the next element while being transferred to a circulation tank at a necessary rate.

The quality of the excavation stabilizing slurry, which contained the thickening agent of the present invention containing an alkali-thickening emulsion, was examined by sampling the slurry at the feed opening through which the excavation stabilizing slurry was sent from the circulation tank for filling an excavation trench and by measuring the specific gravity, sand content, funnel viscosity, and water loss thereof. The quality of the excavation stabilizing slurry, which contained the thickening agent of the present invention containing an alkali-thickening emulsion, is shown in Table 15.

TABLE 15

Quality of excavation stabilizing slurry

| | | Sand | Funnel | |
|---|---|---|---|---|
| Number of | Specific | content | viscosity | Water loss |
| elements | gravity | (%) | (sec) | (ml) |
| 0 | 1.012 | 0 | 27.8 | 10.8 |
| 1 | 1.036 | 0.3 | 27.0 | 10.0 |
| 2 | 1.048 | 0.4 | 27.3 | 9.7 |
| 3 | 1.060 | 0.4 | 26.7 | 11.3 |
| 4 | 1.072 | 0.6 | 26.4 | 12.4 |
| 5 | 1.085 | 0.7 | 25.8 | 12.8 |
| 6 | 1.087 | 0.8 | 26.5 | 13.5 |
| 7 | 1.070 | 0.6 | 26.0 | 13.8 |
| 8 | 1.075 | 0.6 | 25.7 | 13.0 |
| 9 | 1.070 | 0.5 | 25.5 | 13.2 |
| 10 | 1.072 | 0.5 | 25.2 | 13.7 |
| 11 | 1.068 | 0.4 | 25.0 | 14.0 |
| 12 | 1.089 | 0.8 | 26.3 | 14.8 |
| 13 | 1.080 | 0.5 | 25.5 | 14.5 |
| 14 | 1.073 | 0.5 | 25.0 | 14.0 |
| 15 | 1.076 | 0.4 | 24.6 | 14.6 |
| 16 | 1.082 | 0.4 | 24.5 | 14.5 |
| 17 | 1.085 | 0.6 | 25.0 | 15.4 |
| 18 | 1.090 | 0.9 | 25.8 | 16.4 |
| 19 | 1.079 | 0.5 | 24.8 | 16.7 |
| 20 | 1.080 | 0.3 | 24.0 | 16.4 |
| 21 | 1.086 | 0.6 | 24.6 | 17.6 |
| 22 | 1.083 | 0.4 | 24.8 | 19.7 |
| 23 | 1.085 | 0.3 | 24.3 | 21.4 |
| 24 | 1.093 | 0.7 | 26.0 | 23.8 |

As apparent from the results given in Table 15, when the thickening agent of the present invention, which contained an alkali-thickening emulsion, was used in diaphragm wall construction method, then the excavation soil and sand which had contaminated the excavation stabilizing slurry could be efficiently separated although the excavation soil was a fine-grained soil including clay, silt, and mudstone. The repetitions of use of the excavation stabilizing slurry did not result in an increase in specific gravity, sand content, funnel viscosity, or water loss and the excavation stabilizing slurry had satisfactory quality.

Furthermore, since the excavation soil and sand which had contaminated the excavation stabilizing slurry could be efficiently removed with the soil-and-sand separator, the dredging, which is an operation conducted on the termination of excavation, could be carried out in a short time period. The amount of the sand contained in the excavation stabilizing slurry recovered in concrete placing was as small as 1% or less.

The total amount of the excavation stabilizing slurry of the present invention prepared was 2,700 m³ in contrast to the total excavation soil amount of 7,330 m³, and the degree of reuse, which is an index to the suitability of an excavation stabilizing slurry for repetitions of use, was as high as 2.7, which was higher than degrees of reuse of from 1.5 to 1.9 in prior-art diaphragm wall construction methods. The excavation could be completed with such a high degree of reuse.

While the present invention has been described in detail and with reference to specific embodiments thereof, it will be apparent to one skilled in the art that various changes and modifications can be made therein without departing from the spirit and scope thereof.

This application is based on a Japanese patent application filed on Apr. 27, 2001 (Patent Application 2001-132292), the contents thereof being hereby incorporated by reference.

### INDUSTRIAL APPLICABILITY

The thickening agent for excavation stabilizing slurries of the present invention attains extraordinarily reduced bubbling properties. Consequently, the excavation stabilizing slurry containing this thickening agent enables construction works to be stably conducted without the necessity of further adding an antifoamer, unlike the related-art excavation stabilizing slurries containing the conventional emulsion, emulsifying agent, or the like. The excavation stabilizing slurry containing the thickening agent for excavation stabilizing slurries of the present invention further has excellent cement contamination resistance, is less apt to putrefy than those containing CMC, and can be reused many times.

Furthermore, when the excavation stabilizing slurry containing the thickening agent for excavation stabilizing slurries of the present invention is used in the diaphragm wall construction method or underground pile method, the wall faces formed by excavation can be prevented from collapsing without fail. In addition, the excavation stabilizing slurry can be reused many times to diminish waste slurry treatment and is advantageous also from the standpoint of profitability.

1. A thickening agent for excavation stabilizing slurries which contains an emulsion thickening with an alkali, characterized in that in a strong agitation bubbling test of a mixture prepared by adding an alkaline substance to the thickening agent, the resulting mixture has an apparent specific gravity of 1.05 g/ml or higher as measured immediately after the strong agitation and has an apparent specific gravity of 1.10 g/ml or higher as measured at 10 minutes after the strong agitation.

2. The thickening agent for excavation stabilizing slurries as claimed in claim 1, characterized in that the emulsion contains a copolymer comprising, as comonomer units, one or more carboxyl-containing polymerizable monomers (including ones in which the carboxyl groups are partly or wholly a salt) in a total amount of 50% by mass or higher and nonionic polymerizable monomers having a solubility in 20° C. water of 3% by mass or higher.

3. The thickening agent for excavation stabilizing slurries as claimed in claim 2, characterized in that the nonionic polymerizable monomer having a solubility in 20° C. water of 3% by mass or higher is methyl acrylate.

4. An excavation stabilizing slurry, characterized by containing the thickening agent for excavation stabilizing slurries as claimed in any one of claims 1 to 3.

5. A cast-in-place underground pile method, characterized by conducting underground excavation using the excavation stabilizing slurry as claimed in claim 4.

6. A diaphragm wall construction method, characterized by conducting underground excavation using the excavation stabilizing slurry as claimed in claim 4.
